(19) United States
(12) Patent Application Publication
(10) Pub. No.: US 2014/0172386 A1
(43) Pub. Date: Jun. 19, 2014

(54) Simulation Of Shot-Noise Effects In A Particle-Beam Lithography Process And Especially An E-Beam Lithography Process

(71) Applicants: Aselta Nanographics, Grenoble (FR); Commissariat A L'Energie Atomique Et Aux Energies Alternatives, Paris (FR)

(72) Inventor: Jerome Belledent, Meylan (FR)

(21) Appl. No.: 14/105,648

(22) Filed: Dec. 13, 2013

(30) Foreign Application Priority Data
Dec. 18, 2012 (FR) 12 62228

(51) Int. Cl. G06F 17/50

(52) U.S. Cl. CPC G06F 17/5009
USPC 703/2

(57) ABSTRACT

Method for simulating shot-noise effects in a particle-beam lithography process, and especially an e-beam lithography process, the process including depositing particles on the surface of a sample in a preset pattern by a beam of the particles, the pattern being subdivided into pixels and a nominal dose of particles being associated with each of the pixels, wherein the process includes the calculation of a map σ_{d} of standard deviation in the normalized dose actually deposited in each of the pixels, the map of standard deviation being calculated from a map M₀ of the nominal dose associated with each pixel and a point spread function PSF characterizing the process; the method being implemented by computer. Computer program product for implementing and computer programmed to implement such a method. Particle-beam lithography process, and especially an e-beam lithography process, having a prior operation of simulating shot-noise effects using such a method.

### CROSS REFERENCE TO RELATED APPLICATIONS

This application claims priority from French Application No. 12 62228, filed Dec. 18, 2012, which is hereby incorporated herein in its entirety by reference.

### FIELD

The invention relates to a computational method for simulating shot-noise effects in a particle-beam lithography process. The method in particular applies to e-beam lithography, but also, more generally, to any lithography process using beams of particles (including photons) liable to be affected by shot noise: X-ray lithography, laser-beam lithography, ion-beam lithography, etc. It will be recalled that shot noise is due to the discrete nature of the beam; therefore it is all the more important to take into consideration the fact that the dose used corresponds to a small number of particles.

### BACKGROUND

Because of shot noise, structures defined by lithography have irregularly shaped edges the positions of which do not coincide exactly with those that would be expected from a deterministic simulation of the process. This places a lower limit on the critical dimension (CD) that can reliably be produced.

Conventionally, shot noise is simulated using Monte-Carlo methods; a Monte-Carlo algorithm is schematically illustrated in FIG. 1.

The noise is simulated by a random number generator and represented by a matrix Bₙ of independent random variables (elements b_{i,j} obeying a Poisson distribution), which matrix is added to a pixelated pattern to be produced by lithography, which pattern is in turn represented by a matrix M₀ the elements of which are denoted m_{0i,j}. Next, the noisy pattern obtained is convoluted with a point spread function PSF (also represented by a matrix PSF the elements of which are denoted psfᵢⱼ) that depends on beam dispersion effects, but also on the properties of the lithography resist exposed by said beam and its development process, and that therefore characterizes the process. In practice, the convolution M₀ [symbol] PSF is conventionally calculated in the Fourier domain, by multiplying the two-dimensional Fourier transform (FT) of the noisy pattern by that, previously stored in memory, of the PSF, then by carrying out the inverse Fourier transform (FT⁻¹) of the result: M₀ [symbol] PSF=TF⁻¹[TF(M₀)*TF(PSF)]. Thus, a map Dₙ of simulated dose is obtained for one possible occurrence (of index “n”) of the random process that is the exposure of the resist in the presence of noise. By comparing the simulated dose Dₙ with a threshold value that depends on the resist used, a representation of the exposure of the resist, and therefore of the structures that will be acquired after the resist has been developed and the sample on which the resist is deposited has been etched, is obtained. Conventional image processing methods then allow the outlines of said structures to be extracted. This process is repeated several hundred times, the shot noise matrix being changed each time, in order to enable statistical study of the process.

Implementation of this method is very resource intensive because all the operations must be repeated for each noise matrix, and the calculations performed cannot be reused. In particular, generating the shot noise requires a random variable to be associated with each pixel of the pattern. A matrix of random variables, such as Bₙ, may be calculated using Cholesky decomposition of the correlation matrix, but this operation is highly complex from a computational point of view and in terms of memory consumption.

### SUMMARY

The invention aims to provide a method for simulating shot-noise effects in particle-beam lithography processes, which method is simpler and more rapid than known prior-art methods.

One subject of the invention allowing this aim to be achieved is a method for simulating shot-noise effects in a particle-beam lithography process, the process comprising depositing particles on the surface of a sample in a preset pattern by means of a beam of said particles, said pattern being subdivided into pixels and a nominal dose of particles being associated with each of said pixels, characterized in that it comprises the calculation of a map σ_{d} of standard deviation in the normalized dose actually deposited in each of said pixels, said map of standard deviation being calculated from a map M₀ of said nominal dose associated with each pixel and a point spread function PSF characterizing said process; said method being implemented by computer.

In particular, said map σ_{d} of standard deviation may be calculated by applying the following formula:

$${σ}_{{d}_{{i}_{0} , {j}_{0}}} = \sqrt{{\sum }_{i , j} \frac{{psf}_{i - {i}_{0} , j - {j}_{0}}^{2}}{〈 {m}_{i , j} 〉} ( 〈 {m}_{i , j} 〉 > 0 )}$$

where

$${σ}_{{d}_{{i}_{0} , {j}_{0}}}$$

is the element of said map σ_{d} corresponding to the pixel of coordinates (i₀,j₀), psf_{i,j} is the value of the point spread function PSF in the pixel of coordinates (i,j), and [symbol] m_{i,j} [symbol] =m_{0i,j} is the element of said map M₀ of the nominal dose, expressed in the number of particles deposited, associated with the pixel of coordinates (i,j), the sum being carried out over all the pixels for which [symbol] m_{i,j} [symbol] >0.

In the particular case where the nominal dose [symbol] m_{i,j} [symbol] associated with each pixel of coordinates (i,j) has a value chosen uniquely from 0 and a positive integer N (i.e. where a given nominal dose is applied to all the pixels that must be exposed, a dose of zero being applied to the other pixels of the pattern), said map σ_{d} of standard deviation can be calculated by applying the following formula, which is derived from the preceding formula but has a simpler form:

$${σ}_{{d}_{{i}_{0} , {j}_{0}}} = \frac{1}{N} \sqrt{{\sum }_{i , j} {psf}_{i - {i}_{0} , j - {j}_{0}}^{2} 〈 {m}_{i , j} 〉}$$

The method may also comprise a step of determining a positional range for the edges of at least one structure produced on said sample by means of said lithography process, said step comprising:
calculating a first and a second map D₁, D₂ of simulated dose;
comparing each of said maps to a threshold dose value in order to define at least one pattern structure on said sample; and
identifying the edges of each of said pattern structures;

said positional range being comprised between the edges thus identified;

said maps of simulated dose being calculated, respectively, by adding and taking away kσ_{d}, where k>0, to/from a map D₀ of deterministic dose, obtained by convoluting said map M₀ of associated nominal dose and said point spread function PSF.

In particular, k may be chosen to be equal to 3.

As a variant or in addition, the method may also comprise a step of calculating a map D of simulated dose by adding a map δₙ of shot noise to a map D₀ of deterministic dose (including the effects of the point spread function, which is assumed to be known, but not those of the noise), in which:
said map D₀ of deterministic dose is obtained by convoluting said map M₀ of nominal dose and said point spread function PSF; and
said map δₙ of shot noise is obtained by multiplying, element by element, said map σ_{d} of standard deviation by a normalized error map Eₙ having a correlation length given by said point spread function PSF.

In particular, said normalized error map may be calculated by convoluting said point spread function with a matrix ε the elements of which, associated with respective pixels of the pattern, are independent Gaussian random variables of unitary standard deviation, and by normalizing the result by dividing it by a factor Σ_{i,j}psf_{i,j}².

In order to perform statistical studies, said step of calculating a map of simulated dose may be repeated a plurality of times using normalized error maps Eₙ obtained by a random circular permutation of the rows and columns of a single normalized error map called the mother error map E; it is worthwhile noting that only the calculation of the error maps and their addition to the map of deterministic dose must be iterated; and that the calculation of error maps in this way is much simpler than was the case for prior-art methods.

The normalized error maps Eₙ thus obtained may be used as input variables of a physico-chemical model of the resist.

As a variant, the method may also comprise a step of comparing each of said maps of simulated dose to a threshold dose value in order to define at least one respective pattern structure on said sample, and a step of identifying the edges of each of said pattern structures.

Advantageously, the method may comprise:

a) calculating and storing in a computer memory said map D₀ of deterministic dose, said map σ_{d} of standard deviation in the normalized dose, and said mother error map E;

b) calculating said map δₙ of shot noise by circular permutation of the rows and columns of said mother error map E and by multiplying it, element by element, with said map σ_{d} of standard deviation in the normalized dose; and

c) calculating a map D of simulated dose by adding said map D₀ of deterministic dose to said map δₙ of shot noise,

said steps b) and c) being repeated a plurality of times with different circular permutations of the rows and columns of said mother error map E.

As explained above, said particle-beam lithography process may in particular be an e-beam lithography process.

In particular, said lithography process may use vector addressing of the beam, the method also comprising an operation of conceptually subdividing said pattern into pixels and determining a dose received by each of said pixels.

Another subject of the invention is a computer program product for implementing such a method.

Yet another subject of the invention is a computer programmed to implement such a method.

Yet another subject of the invention is a particle-beam lithography process comprising a prior operation of simulating shot-noise effects using such a method. Such a process may in particular be used to fabricate electronic or optoelectronic components, integrated circuits, microelectromechanical devices (MEMS) and/or photolithography masks.

### BRIEF DESCRIPTION OF THE DRAWINGS

Other features, details and advantages of the invention will become apparent on reading the description given with reference to the appended drawings (given by way of example) in which:

FIG. 1 schematically illustrates a Monte-Carlo algorithm;

FIG. 2 is a flow chart of a method according to two embodiments of the invention;

FIG. 3 shows a lithography pattern to be produced, which pattern is used to illustrate the method of the invention;

FIGS. 4A-C, 5 and 6 justify the validity of the calculation of the map σ_{d} of standard deviation in the normalized dose actually deposited on the sample in correspondence with each pixel of the pattern in FIG. 3;

FIG. 7 illustrates the autocorrelation function of the dose actually deposited at a specific location on the sample;

FIG. 8A is an error map obtained according to the invention, and FIG. 8B is a graph of its correlation function, compared to that obtained for a lithography pattern containing noise obeying Poisson statistics;

FIG. 9 illustrates the technical result of the invention by comparing a positional range of the edges of a structure produced by e-beam lithography, determined by a method according to the invention (9A) and by a method according to the prior art (9B).

### DETAILED DESCRIPTION

The invention will be described below with reference to a “raster image” e-beam lithography process, i.e. one using a “spot” electron beam to sweep out a pixelated pattern point-by-point on a sample covered with a lithography resist. However, as was mentioned above, it also applies to processes using particles other than electrons. The invention is also applicable to lithography techniques using vector addressing, for example to beams having a preset shape (generally rectangular) and a size that varies from exposure field to exposure field. In this case, the writing zone is conceptually subdivided (rendered) into pixels, it being assumed that the dose has a uniform distribution inside each of said preset zones, and the dose received by each pixel is determined, thereby reducing this case to that of a raster image process.

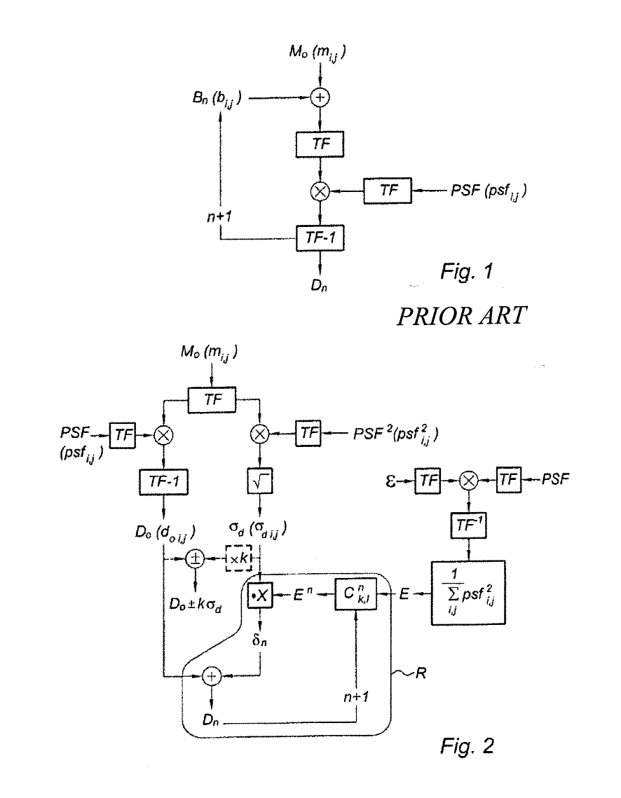

An algorithmic representation of a process according to the invention is illustrated by the flow chart in FIG. 2. As may be seen, this process comprises two main parts, which may be implemented in any order or in parallel: calculation of a map (or matrix) D₀ of deterministic dose (of elements d_{i,j}) including the effects of the point spread function, which is assumed to be known, but not those of the noise (left-hand branch of the flow chart); and the calculation of a map (or matrix) δₙ of shot noise (right-hand branch). The dose map Dₙ corresponding to a specific instance of shot noise is obtained simply by adding the map of deterministic dose and the map δₙ corresponding to said instance of shot noise: Dₙ=D₀+δₙ. The left-hand branch of the flow chart corresponds to operations that, for a given lithography pattern M₀ and for a given lithography process, characterized by a point spread function PSF, must be carried out once only; it is simply a question of convoluting the matrices M₀ and PSF. The map D₀ thus calculated may then be stored in memory. As will be explained below, the right-hand branch comprises both operations that may be carried out once only, leading to intermediate results intended to be stored in memory, and operations that must be repeated for each shot noise matrix. Pooling a large part of the operations, and the storage of intermediate results in memory, allow a significant saving to be made in terms of the computational resources employed relative to the algorithm in FIG. 1, where all or nearly all the operations must be repeated for each noise matrix.

According to the invention, the calculation of the matrix δₙ of shot noise is split into three parts: the calculation of a map σ_{d} each element of which represents the standard deviation in the normalized dose deposited in the pixel of coordinates (i₀,j₀); the calculation of a normalized error map called the “mother” map E having a correlation length given by the point spread function PSF; and the calculation of δₙ from σ_{d} and E.

According to one particularly advantageous feature of the invention, the map σ_{d} is calculated deterministically, from the pattern M₀ and the point spread function PSF: therefore, this calculation must be performed once only, and the map of standard deviation is therefore an intermediate result that can be stored in memory.

According to another particularly advantageous feature of the invention, the “mother” map E is also an intermediate result, calculated once only from a matrix ε of independent random variables and from the point spread function PSF.

Therefore, only the calculation of δₙ from E and σ_{d} and the sum D₀+δₙ allowing Dₙ to be found (part of the flow chart denoted R) must be repeated a number of times. However, as will be shown below, these operations are very simple.

Furthermore, in most cases, it is not even necessary to calculate the dose map Dₙ for a number of shot noise matrices. If the aim is only to determine a “probable” positional range for the edges of a structure produced by e-beam lithography, it may be enough to consider two extreme cases: that where each pixel of the pattern receives a dose that is substantially higher than the expected average value, and that where each pixel of the pattern receives a dose that is substantially lower than said average value. These extreme cases are obtained by adding and taking away the matrix kσ_{d}, where k>0, to/from the map D₀ of deterministic dose. It will be understood that the higher k is, the lower the risk of obtaining an edge outside of the calculated range, but the greater the width of said range; hence, choosing a k value that is too high will lead to an excessively pessimistic estimation of the critical dimension of the process. In practice, the value of k will generally be set to k=3. This second simplified embodiment of the method is illustrated with dotted lines in the flow chart in FIG. 2.

In FIG. 2, as moreover in FIG. 1, the convolution operations are carried out in the Fourier domain. This is an advantageous but non-essential feature of the method.

Following this general illustration of the method, the calculation of σ_{d} and its use to determine δₙ will now be considered. The other operations implemented by the method are simple (convolutions and sums) and do not require particular attention.

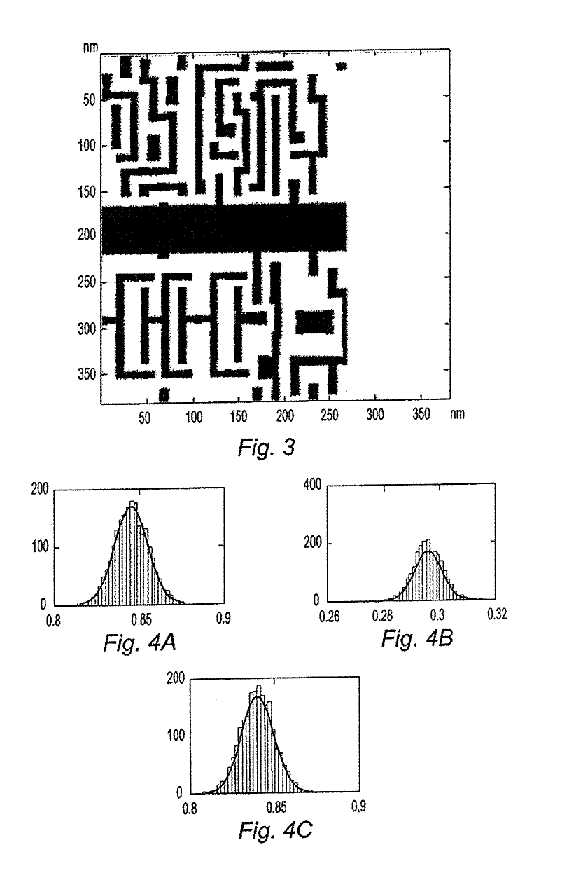

The calculation of the map σ_{d} of standard deviation will be examined first with regard to the case of a pattern such as that illustrated in FIG. 3, where the nominal dose that it is desired to deposit in each pixel is either 0 (white pixels) or a positive integer N (black pixels). The dose actually deposited on the sample during the “writing” of each pixel is in fact expressed by a random variable m_{i,j} having a probability distribution following Poisson's law, and the average value [symbol] m_{i,j} [symbol] =m_{0i,j} of which is either 0 or N. Furthermore, the m_{i,j} electrons directed onto the sample during the writing of the pixel of coordinates (i,j) will in fact be distributed over a plurality of pixels due to the finite width of the point spread function PSF. The normalized dose D is defined by the convolution of M and PSF, divided by N:

$$D = \frac{1}{N} M ⊗ PSF = \frac{1}{N} {\sum }_{i , j} {m}_{i , j} {psf}_{i - {i}_{0} , j - {j}_{0}}$$

Each element d_{i,j} of the matrix D then results from the summation of independent random variables, the number of which is large enough for the central limit theorem to be applied. Therefore, each element of D follows a Gaussian distribution the standard deviation σ of which is equal to the square root of the quadratic sum of the standard deviations of all the pixels of the pattern. In fact it will be noted, strictly speaking, that the probability density function cannot be rigorously Gaussian because negative values of the normalized dose are forbidden. However, if the standard deviation is sufficiently small relative to the average value, this can be neglected.

Carrying out this calculation gives:

$${σ}_{{d}_{{i}_{0} , {j}_{0}}} = \sqrt{{\sum }_{i , j} ( {σ}_{\frac{{m}_{i , j} {psf}_{i - {i}_{0} , j - {j}_{0}}}{N}} )} = \sqrt{{\sum }_{i , j} \frac{{psf}_{i - {i}_{0} , j - {j}_{0}}^{2}}{〈 {m}_{i , j} 〉} ( 〈 {m}_{i , j} 〉 > 0 )} \qquad ( 1 )$$

As the standard deviation of the random variable m_{i,j}, σₘ_{_{i,j}}=\sqrt{N} and

$$\frac{〈 {m}_{i , j} 〉}{N} = 0$$

or 1, the above equation may be simplified as follows:

$${σ}_{{d}_{{i}_{0} , {j}_{0}}} = \frac{1}{N} \sqrt{{\sum }_{i , j} {psf}_{i - {i}_{0} , j - {j}_{0}}^{2} 〈 {m}_{i , j} 〉} ⇒ {σ}_{d} = \frac{1}{N} \sqrt{{PSF}^{2} ⊗ {M}_{0}} \qquad ( 2 )$$

In conclusion, in the case where m_{0i,j} is either 0 or N (case considered in the flow chart in FIG. 2, but only by way of nonlimiting example) the map σ_{d} of standard deviation is obtained by calculating the convolution of the map M₀ of nominal dose with the function PSF², then by taking the square root of the result.

The validity of equation 2 has been tested by simulating the pattern in FIG. 3 2048 times with a PSF given by:

$$PSF ( r ) = \frac{1}{π ( 1 + η )} ( \frac{1}{{α}^{2}} {e}^{- \frac{{r}^{2}}{{α}^{2}}} + \frac{η}{{β}^{2}} {e}^{- \frac{{r}^{2}}{{β}^{2}}} )$$

where r is the radial distance relative to the centre of the beam, α=25.2; β=297; η=0.48 and with a nominal dose of 30 μC/cm².

FIGS. 4A, 4B and 4C show histograms of the dose actually received in three pixels of coordinates (179,130), (188, 271) and (188, 175); the histogram in FIG. 4A is that which has the highest asymmetry coefficient or “skewness” (i.e. this dose histogram has the greatest skew towards high doses), that in FIG. 4B is that which has the lowest skewness (i.e. this dose histogram has the greatest skew towards low doses), and that in FIG. 4C has a skewness of zero (i.e. its dose histogram is symmetric). A line shows the best Gaussian interpolation. Specifically, these figures allow it to be verified that the normalized dose d_{i,j} follows a substantially Gaussian distribution, which was precisely the assumption on which the derivation of equations 1 and 2 was based.

FIG. 5 shows the relationship between the standard deviation in the measured normalized dose based on 2048 simulations (vertical y-axis) and the standard deviation calculated using equation 1 (horizontal x-axis). A linear relationship is observed with a slope very close to 1 and a y-intercept of 0.

The left-hand part of FIG. 6 shows a grey-scale representation of the difference between the maps of measured and calculated standard deviation, allowing it to be verified qualitatively that this difference does not depend on the features of the lithography pattern (reproduced, by way of reminder, in the right-hand part of the figure).

As explained above, the map σ_{d} of standard deviation calculated using equation 1 or 2 allows a positional range to be determined for the edges of a structure produced by e-beam lithography. Furthermore, knowledge of σ_{d} allows the map δₙ of shot noise to be calculated. Specifically, according to one advantageous aspect of the invention, said map δₙ is obtained by multiplying, element by element, σ_{d} and an error map Eₙ represented by a matrix of correlated random variables having a Gaussian distribution and a standard deviation equal to 1:

δₙ=Eₙ·×δ_{d} (3)

where “·×” is the element-by-element multiplication operator.

There are a number of ways in which a matrix of random variables having the required autocorrelation properties can be calculated; for example it would be possible, as is conventional, to carry out a Cholesky decomposition of the characteristic correlation matrix of the process, and deduce therefrom the correlated random variables. However, according to one advantageous aspect of the invention it is preferable to calculate this matrix by convoluting a matrix of independent and identically distributed random variables, denoted ε, with the point spread function PSF. Even more advantageously, this calculation may be carried out only once, in order to give what is called a “mother” matrix E. The various matrices Eₙ may be obtained by a circular permutation of the rows and columns of said “mother” matrix. In conclusion, expressing the convolution calculation in the Fourier domain, it is possible to write:

$$\begin{matrix}E = \frac{{TF}^{- 1} [ TF ( ɛ ) \cdot TF ( PSF ) ]}{\sqrt{{\sum }_{i , j} {psf}_{i , j}^{2}}} & ( 4 ) \\ {δ}_{n} = {C}_{k , I} ( E ) \cdot \times {σ}_{d} & ( 5 )\end{matrix}$$

where C_{k,l} is the operator that circularly permutates the rows and columns of its argument k and l times, respectively. Advantageously, k and l are chosen randomly.

Thus, the only operations that must be repeated a number of times to perform a statistical study of the lithography process are: the circular permutation of the rows and columns of the mother matrix E (stored in memory beforehand) to determine Eₙ; the element-by-element multiplication of said matrix Eₙ and of the map σ_{d} of standard deviation (also stored beforehand in memory) to find δₙ; and, lastly, the sum of D₀ (which is in turn an intermediate result stored beforehand in memory) and of δₙ to obtain Dₙ:

Dₙ=D₀+δₙ (6)

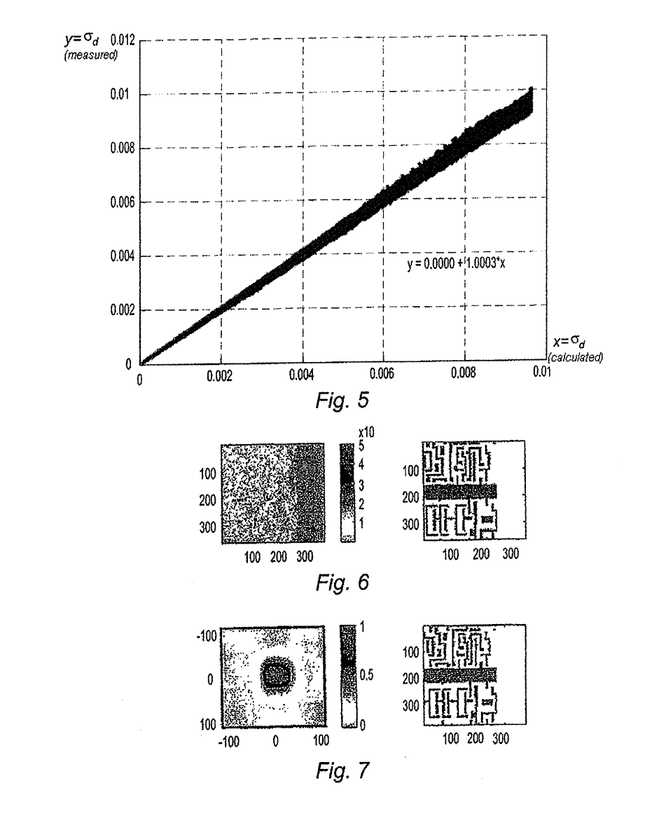

By way of example, the left-hand part of FIG. 7 shows the autocorrelation function of the normalized dose calculated for the pixel of the pattern identified by the cross visible in the right-hand part of the same figure. This calculation allows it to be verified that the correlation length is qualitatively related to the width of the point spread function.

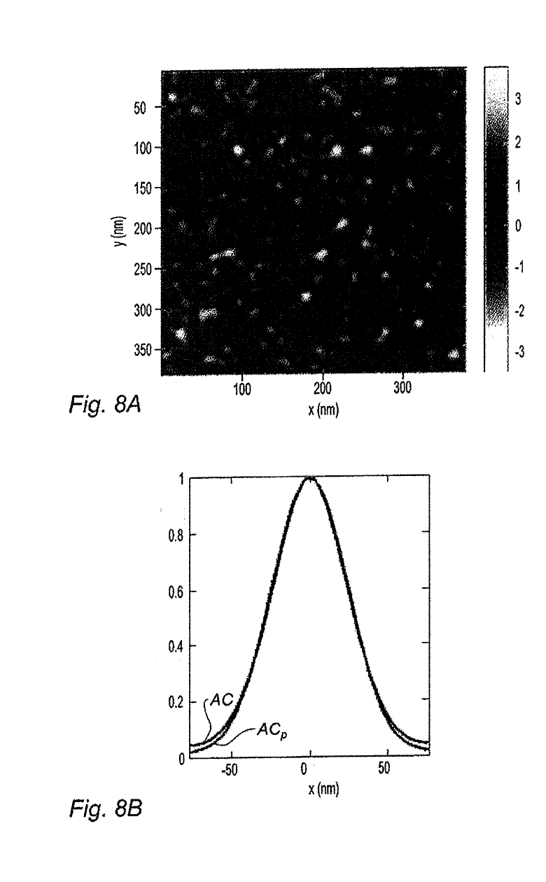

FIG. 8A shows an error map obtained according to the invention (calculation of the mother map by application of equation 4, then circular permutation of its rows and columns). FIG. 8B shows a plot of the autocorrelation function AC, which proves to be practically identical to that (AC_{P}) calculated from a random pattern having a Poisson distribution.

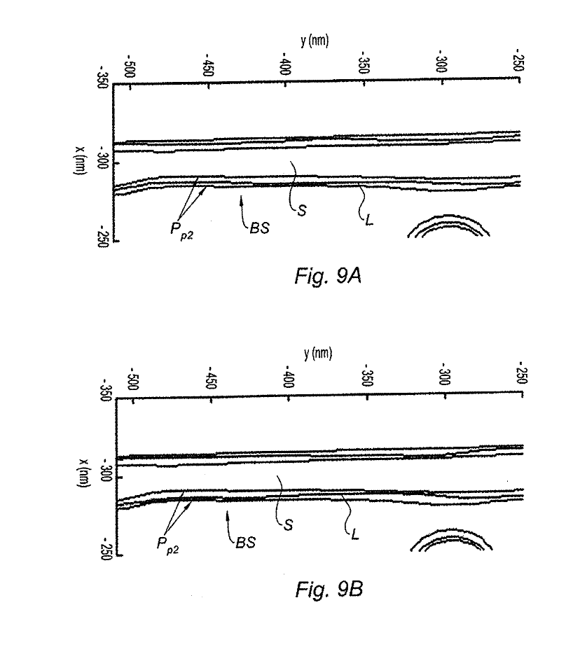

FIGS. 9A and 9B allow it to be verified that, despite its noteworthy computational simplicity, the method of the invention enables results that are practically identical to those of the conventional method, illustrated by the flow chart in FIG. 1, to be obtained. These two figures show a structure S produced by e-beam lithography; more precisely this structure is an approximately rectilinear track having edges BS. In particular because of shot noise, there is uncertainty in the position of these edges; for this reason, each edge is represented by two lines bounding a positional range P_{PL}; a line L located inside this range corresponds to an edge obtained for a particular embodiment of the process. In the case in FIG. 9A, the positional range P_{PL} was defined by comparing the maps D₀+3σ_{d} and D₀−3σ_{d} to a threshold value of the dose for the lithography resist used in the process, σ_{d} being given by equation 2, whereas the line L was obtained by thresholding from a dose map Dₙ, generated by applying equation 6. In contrast, FIG. 9B was obtained by a complete Monte-Carlo simulation according to the prior art. The similarity between these two figures is remarkable, whereas the time saving obtained by the invention, relative to the conventional Monte-Carlo simulation, is about a factor of 5000.

If it is desired to carry out a precise statistical study of the effects in play, the dose map Dₙ will be calculated for a plurality of different shot noise matrices, and each map Dₙ thus calculated will be used as an input variable of a complex physico-chemical model of resist sensitivity.

1. Method for simulating shot-noise effects in a particle-beam lithography process, the process comprising depositing particles on the surface of a sample in a preset pattern by means of a beam of said particles, said pattern being subdivided into pixels and a nominal dose of particles being associated with each of said pixels, characterized in that it comprises the calculation of a map σ_{d} of standard deviation in the normalized dose actually deposited in each of said pixels, said map of standard deviation being calculated from a map M₀ of said nominal dose associated with each pixel and a point spread function PSF characterizing said process; said method being implemented by computer.

2. Method according to claim 1, in which said map σ_{d} of standard deviation is calculated by applying the following formula:
$${σ}_{{d}_{{i}_{0} , {j}_{0}}} = \sqrt{{\sum }_{i , j} \frac{{psf}_{i - {i}_{0} , j - {j}_{0}}^{2}}{〈 {m}_{i , j} 〉} ( 〈 {m}_{i , j} 〉 > 0 )}$$
where
$${σ}_{{d}_{{i}_{0} , {j}_{0}}}$$
is the element of said map σ_{d} corresponding to the pixel of coordinates (i₀,j₀), psf_{i,j} is the value of the point spread function PSF in the pixel of coordinates (i,j), and [symbol] m_{i,j} [symbol] is the element of said map M₀ of the nominal dose, expressed in the number of particles deposited, associated with the pixel of coordinates (i,j), the sum being carried out over all the pixels for which [symbol] m_{i,j} [symbol] >0.

3. Method according to claim 2, in which the nominal dose [symbol] m_{i,j} [symbol] associated with each pixel of coordinates (i,j) has a value chosen uniquely from 0 and a positive integer N, and in which said map σ_{d} of standard deviation is calculated by applying the following formula:
$${σ}_{{d}_{{i}_{0} , {j}_{0}}} = \frac{1}{N} \sqrt{{\sum }_{i , j} {psf}_{i - {i}_{0} , j - {j}_{0}}^{2} 〈 {m}_{i , j} 〉}$$

4. Method according to claim 1, also comprising a step of determining a positional range for the edges of at least one structure produced on said sample by means of said lithography process, said step comprising:
calculating a first and a second map D₁, D₂ of simulated dose;
comparing each of said maps to a threshold dose value in order to define at least one pattern structure on said sample; and
identifying the edges of each of said pattern structures;
said positional range being comprised between the edges thus identified;
said maps of simulated dose being calculated, respectively, by adding and taking away kσ_{d}, where k>0, to/from a map D₀ of deterministic dose, obtained by convoluting said map M₀ of associated nominal dose and said point spread function PSF.

5. Method according to claim 4, in which k=3.

6. Method according to claim 1, also comprising a step of calculating a map D of simulated dose by adding a map δₙ of shot noise to a map D₀ of deterministic dose, in which:
said map D₀ of deterministic dose is obtained by convoluting said map M₀ of nominal dose and said point spread function PSF; and
said map δₙ of shot noise is obtained by multiplying, element by element, said map σ_{d} of standard deviation by a normalized error map Eₙ having a correlation length given by said point spread function PSF.

7. Method according to claim 6, in which said normalized error map is calculated by convoluting said point spread function with a matrix ε the elements of which, associated with respective pixels of the pattern, are independent Gaussian random variables of unitary standard deviation, and by normalizing the result by dividing it by a factor Σ_{i,j}psf_{i,j}².

8. Method according to claim 6, in which said step of calculating a map of simulated dose is repeated a plurality of times using normalized error maps Eₙ obtained by a random circular permutation of the rows and columns of a single normalized error map called the mother error map E.

9. Method according to claim 8, in which the normalized error maps Eₙ thus obtained are used as input variables of a physico-chemical model of the resist.

10. Method according to claim 8, also comprising a step of comparing each of said maps of simulated dose to a threshold dose value in order to define at least one respective pattern structure on said sample.

11. Method according to claim 10, also comprising a step of identifying the edges of each of said pattern structures.

12. Method according to claim 8, comprising:
a) calculating and storing in a computer memory said map D₀ of deterministic dose, said map σ_{d} of standard deviation in the normalized dose, and said mother error map E;
b) calculating said map δₙ of shot noise by circular permutation of the rows and columns of said mother error map E and by convoluting it with said map σ_{d} of standard deviation in the normalized dose; and
c) calculating a map D of simulated dose by adding said map D₀ of deterministic dose to said map δₙ of shot noise,
said steps b) and c) being repeated a plurality of times with different circular permutations of the rows and columns of said mother error map E.

13. Method according to claim 1, in which said particle-beam lithography process is an e-beam lithography process.

14. Method according to claim 1, in which said lithography process uses vector addressing of the beam, the method also comprising an operation of conceptually subdividing said pattern into pixels and determining a dose received by each of said pixels.

15. Computer program product for implementing a method according to claim 1.

16. Computer programmed to implement a method according to claim 1.

17. Particle-beam lithography process comprising a prior operation of simulating shot-noise effects using a method according to claim 1.
